(19) United States
(12) Patent Application Publication
(10) Pub. No.: US 2019/0176501 A1
(43) Pub. Date: Jun. 13, 2019

(54) COATING FOR ALUMINUM SUBSTRATES

(71) Applicant: Conde Systems, Inc., Mobile, AL (US)

(72) Inventor: Paul Andrew Ramsden, Lewiston, ME (US)

(21) Appl. No.: 16/276,605

(22) Filed: Feb. 14, 2019

Related U.S. Application Data
(63) Continuation-in-part of application No. 15/014,855, filed on Feb. 3, 2016, now Pat. No. 10,253,453.
(60) Provisional application No. 62/112,119, filed on Feb. 4, 2015.
(60) Provisional application No. 62/112,114, filed on Feb. 4, 2015.

(51) Int. Cl. B41M 5/035; B41M 1/30; B05D 5/06; B05D 7/14; C08L 75/16; C08K 3/22

(52) U.S. Cl. CPC B41M 5/0355; B41M 1/30; B05D 5/063; B05D 7/14; C08K 2201/005; C08K 3/22; B05D 2202/25; B05D 2503/00; C08K 2003/2241; C08L 75/16

(57) ABSTRACT

A new polymer coating for metal surfaces that allows for the application of disperse dyes in a sublimation process that preserves the luster and metal iridescence naturally occurring in a metal surface, such as occurs on a polished aluminum sheet. The coating includes a combination of natural metal oxide additives having the capability to be prepared in nano-sized particles and combined with an organic polymer coating binder and resin in restricted loading levels to allow for light penetration to and from the polished metal surface. An optimal loading level for the additive that utilizes particles having a size of between 5 nm and 15 nm of metal oxide additives is approximately 20 percent by weight of solids.

### FIELD OF THE INVENTION

The present invention relates generally to sublimation coatings. In particular, the present invention relates to dye sublimation transfer printing onto synthetic organic polymers and metallic articles. In greater particular, the present invention relates to coatings applied to substrates that enhances the luminosity of disperse dyes.

### BACKGROUND OF THE INVENTION

In the field of imprinting designs onto articles of manufacturer using disperse dyes, known commonly in the industry as dye-sublimation printing, images are transferred from a carrier medium using heat and pressure to activate printed dyes on the medium and causing them to turn into a gas or “sublimate” from their solid state and to diffuse into a softened polymer matrix. For example, an early patent disclosing a dye sublimation transfer was presented in U.S. Pat. No. 4,021,591 issued to Devries. Another sublimation example is shown in a method of imaging a ceramic mug as disclosed in U.S. Pat. No. 4,943,684 issued to Kramer.

Certain fibrous organic materials such as polyester fabric and certain synthetic organic polymers such as acetyl, polycarbonate, and nylon can accept the diffusion of disperse dyes directly and have no need to be coated before receiving the image. However, their natural ability to accept the diffusion of the dye does not ensure long term persistence of these dyes and often the image will blur or fade over time. Moreover, harder substances such as metal are naturally resistant to the diffusion of the disperse dyes through their molecular surface structure and into the underlying metal substrate so that image persistence is even less than that with organic substrates.

For this reason, and to render articles suitable for dye sublimation decoration on persistent, long-term substrates, synthetic organic coatings are typically formulated and employed to pre-coat the substrate being decorated prior to the transfer of the image. An example patent disclosing such coatings used prior to the sublimation of images onto ceramic tiles is U.S. Pat. No. 4,174,250 issued to Durand.

One type of substrate that is popular for the transference and display of sublimated images is aluminum. Aluminum is popular because it typically has a flat and hard surface, which allows for a larger format image to be printed onto a single surface, resulting in higher visibility of the image and achieving a greater viewer impact. Also, aluminum is ductile which allows for a final decorated article to be light and highly durable. In fact, the typical thickness of an aluminum sheet used for dye sublimation is between 0.020 inches (0.5 mm) and 0.050 inches (1.25 mm) thick, but preferably around 0.04 inches (1.0 mm) thick. So, a finished dye sublimation aluminum article is relatively light and can be easily mounted on a wall in large format sizes. Also aluminum is capable of withstanding the high temperatures associated with the dye sublimation transfer process, namely 325-410 degrees F.

As indicated above, because virtually no diffusion of a disperse dye can occur into a metal surface, it is necessary for a polymer coating to be applied to a metal surface prior to attempting to sublimate an image onto the substrate. In addition, the background luster of a metal substrate, such as aluminum, provides a naturally reflective surface from which a clear polymer coating allows for a deposited image to have a higher level of luminosity than a non-reflected surface.

However, even when aluminum substrates are highly polished, the application of disperse dyes though sublimation onto coated on Aluminum does not result in the reproduction of vibrant images after deposition as might be expected. The problem is that light, while reflected, is also dispersed and certain wave lengths of visible light are absorbed by the aluminum surface surrounding the deposited image and from behind the image. As it will be understood, disperse dyes are not paint, nor do they include white pigment such as titanium dioxide, which cannot be sublimated. Sublimated dyes must obtain their white color from the substrate onto which an image will be applied, or from within a coating that covers the substrate prior to applying an image. Hence, dye sublimation inks only provide a clear, transparent layer or “non-pigmented” area for an intended white image area in a sublimation image. Further, a metal's surface features are visible through a deposited image, thereby creating a noisy or distracting image area where a continuous color area might be desired. This problem is especially prevalent on skin tones or facial images deposited over a metal substrate. The effect is to cause the deposited image to appear grainy, washed-out and muted, and to include distracting and inconsistent features even when images are adjusted to increase their color content and luminosity. An additional effect is that white areas in an image cannot be reproduced accurately on the metal, rather the white of an image is limited to the color of the underlying metal, which in the case of aluminum is at best a light grey.

An inadequate response to this problem has been to simply paint the surface of the metal white, or some other suitable color, and then add an additional clear coating over the painted layer into which disperse dyes may be sublimated. However, this strategy is unsatisfactory because the natural luster provided by the metal substrate is covered and lost, and only the desirability of the metal physical properties retained. Further, the coating process of metal now presents a more complicated two step layering process, which increases cost and complexity to the metal substrate preparation process prior to depositing an image through dye sublimation.

A further inadequate response is to mix the clear coating and paint pigment together. However, white pigment is almost always micronized titanium dioxide and once that compound is mixed with a clear polymer coating any dispersed dyes sublimated into such a mixed coating will occlude and interfere with reflection of the dyes diffused into the coating, thereby rendering them invisible or hardly perceivable. This occurs because the particle size of the pigment particles is much larger than the particle size of the diffused inks, thereby dominating the reflected light within the mixed polymer coating after diffusion.

Therefore, what is needed is an improved coating for aluminum, and metal surfaces in general, that preserves the benefit of the reflectivity (i.e. the luster) of a metal surface, while also preserving the vibrancy and impact of dye sublimated images placed on such metal surfaces, and to supply such a coating in a simple application process.

### SUMMARY OF THE INVENTION

It is the object of the present invention to provide a new polymer coating for metal surfaces that allows for the application of disperse dyes in a sublimation process that preserves the luster and metal iridescence naturally occurring in a metal surface, such as occurs on a polished aluminum sheet. The coating includes a combination of natural metal oxide additives having the capability to be prepared in nano-sized particles and combined with an organic polymer coating binder and resin in restricted loading levels to allow for light penetration to and from the polished metal surface. An optimal loading level for the additive that utilizes particles having a size of between 5 nm and 15 nm of metal oxide additives is approximately 20-30 percent by weight of solids, depending upon the dry-film thickness of the coating.

Other features and objects and advantages of the present invention will become apparent from a reading of the following description as well as a study of the appended drawings.

### BRIEF DESCRIPTION OF THE DRAWINGS

An invention incorporating the features of the invention is depicted in the attached drawings which form a portion of the disclosure and wherein:

FIG. 1 is a cross sectional diagram of a coated aluminum substrate;

FIG. 2 is a cross sectional diagram of the coated aluminum substrate shown in FIG. 1 positioned within a heat press in the process of receiving a dye sublimation image from a transfer media; and,

FIG. 3 is a cross sectional diagram of the coated metal substrate shown in FIG. 2 after heat and pressure have caused the diffusion of the dye into the polymer coating.

### DESCRIPTION OF THE PREFERRED EMBODIMENTS

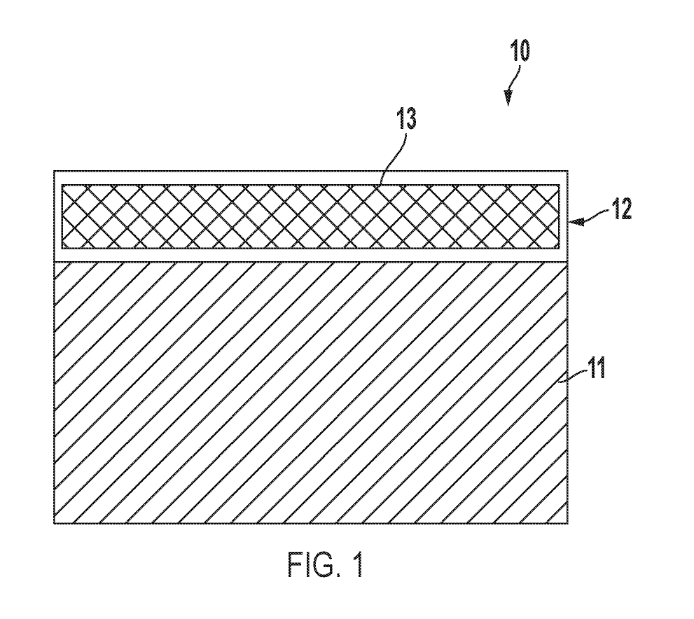

Referring to the drawings for a better understanding of the function and structure of the invention, FIG. 1 shows a cross sectional view 10 of a 1.0 mm thick aluminum substrate 11 coated with a synthetic organic polymer 12 applied thereon, such as an organic binder and resin coupled with an inorganic nano-scale material as will be described. For the purposes of this disclosure, “nano-scale” or “nano-sized” or “nano-particle” is herein defined as any particle having an average mean width of less than one-billionth of a meter. Aluminum substrate 11 is an optically opaque aluminum sheet, having a nominal luster exhibited by medium quality polished aluminum. However, any metal having sufficient ductility to be formed in a relatively thin, smooth sheet of material may be used to the extent that a synthetic organic polymer of the types described herein will adhere to the surface of such metal material. The herein described coating will work with any level of luster exhibited by a polished metal surface, but the greater the iridescence exhibited by the metal surface the greater the effectiveness of promoting a vibrant dye sublimation image exhibiting a metallic iridescence from the image. Further, as may be understood, while thin aluminum sheets are utilized as an example embodiment, the herein disclosed coating may be applied to any thickness of metal material as long as the herein described coating can be applied to the surface and a disperse dye diffused into the coating. For example, a polished side of a ship having a thick metal hull may use the herein described coating and method to apply dispersed dyes to its exterior.

The organic polymer 12 is a clear urethane coating modified by the addition of light scattering additives 13 that renders it a white translucent, partially opaque coating. A suitable light scattering pigment 13 preferably includes nano-sized particles of metal oxide, such as aluminum oxide, having an average particle size of 100 nm at a maxim loading level of 5-10% by weight of solids, but even more preferably utilizes a particle size of approximately 5 nm maximum width with loading level of 20% by weight of solids. The coating 12 is applied by spraying onto the aluminum 11 resulting in a dry film buildup of approximately 0.10 mm (0.004″). In the preferred embodiment, the coating dries at room temperate with a catalyzed reaction to induce polymerization.

However, the inventor has used various metal oxide additives and can obtain satisfactory results across a range of additive formulations by varying loading levels of oxides in response to the added particle size of the metal oxide. For example, as shown in Table 1 below, as the size of oxide particles increases, the loading levels decrease. However, it is critical that the substantial majority of particle sizes are less than 400 nm in size irrespective of the loading level, as shown in Table 1.

TABLE 1

| Preparation | | Loading Levels by |
|---|---|---|
| No. | Particle Size | weight of solids |
| 1. | 5 nm-15 nm | 30% to 40% |
| 2. | 15 nm-50 nm | 20% to 35% |
| 3. | 50 nm-100 nm | 10% to 30% |
| 4. | 100 nm-200 nm | 5% to 20% |
| 5. | 200 nm-400 nm | Approximately 5% |

Coating 12 must be capable of bonding with the aluminum substrate 11, but possess sufficient flexibility to allow the coated article to be flexed by 5-10% as may be encountered during movement with relatively thin sheets of decorated aluminum. Suitable flexible coating bases for aluminum are polyester or urethane, or a hybrid mixture of two of these coating bases. The coating should either be extruded directly onto the product or applied by conventional coating deposition procedures such as spraying, curtain deposition, or flow-over deposition. The coating may be cured either by low temperature thermal activation, or the application of a chemical catalyst, which is preferred. The coating 12 preferably is not cured by photo-initiated or electron-beam initiated reaction because polymers cured in this manner generally do not possess the ability to be heated and flexed after curing without cracking or delamination.

As described, coating 12 includes light scattering additives 13. For a final decorated aluminum article to exhibit the desired optical characteristics the coating must include particulate that is capable of scattering light, as opposed to reflecting the light, and which can then combine with the natural reflected luminosity of an aluminum surface, sometimes referred to as “metallic iridescence,” to magnify the total luminosity of a final image diffused onto a decorated article once the dye sublimation image has been applied. Importantly, the light scattering additives must also exhibit their own level of metallic iridescence so that their light scattering effect adds to and magnifies the pre-existing iridescence of the metal surface. Suitable light scattering particulates for the herein described coating include aluminum oxide, zinc oxide, titanium dioxide, silver oxide, zirconium oxide, and other naturally occurring metal oxides capable of being reduced to nano-sized particles having a cross section of less than 400 nm, and being of white appearance when viewed as agglomerated particulate. Each particulate must be predominately less than 400 nm in size so that each is smaller than any visible wavelength of light. This results in the particulate having a higher refractive index than clear coating surrounding and supporting the particles, resulting in suitable light scattering and a suitable degree of light transmission reflected from the metallic surface. As may be understood, these particulate additives may also render the aluminum substrate more scratch resistant, depending upon the nano-pigment selected. As indicated above, the preferred embodiment for a particle additive is nano-particles of aluminum oxide. This would be the case with the integration of aluminum oxide or zirconium oxide for example. The loading level of the aluminum oxide particulate should be sufficient to impart whiteness and a degree of opacity, but not of such concentrations that the coating ceases to be translucent or partially transparent. Therefore, nanoparticles in a range of 5 nm-400 nm at a loading level of between 5% and 40% by weight of solids of the coating are preferred, as indicated in Table 1.

As suggested in the Table, variations in film thickness, particle loading levels, and mean particle size may be altered to achieve different luminosity characteristics on a metal surface. Further, those individual properties would be tailored in response to the type of reflectivity exhibited by the metal surface onto which an image might be applied, and also in response to the type of lighting effects that might be desired for a particular sublimated image to be deposited on that metal surface. For example, a polished, anodized aluminum surface would require less loading of oxide particle loading to achieve a particular level of luminosity than a standard milled, unbrushed, gray aluminum surface, and a wedding scene image might utilize a higher level of particle loading than say a redwood forest scene. Conversely, a thicker film would allow for less particulate loading the achieve the same level of luminosity for a particular type of surface or image. Hence, the herein described process allows for variations in film thickness, loading, and particle size to suit a particular metal substrate and/or image requirements.

Coating thickness is also important. The coating 12 must be thick enough to allow the light attenuation caused by the particulate contained within it to render the aluminum article reflective and to allow the dyes, in concert with the particulate, to render a degree of opacity while allowing the above described iridescence to propagate away from the substrate. This generally requires a coating thickness of at least 0.0015″, (0.0381 mm), but preferably greater than 0.0025″ (0.0635 mm) in thickness. The coating should not however be greater than 0.005″ (0.127 mm) because disperse dyes may fail to properly diffuse through the coating. The consequence of this is that the iridescence imparted by the particulate present between the aluminum interface and the threshold of the dye saturated part of the coating film causes a desirable metallic iridescence of the image such that any deposited image is enhanced with additional luminosity.

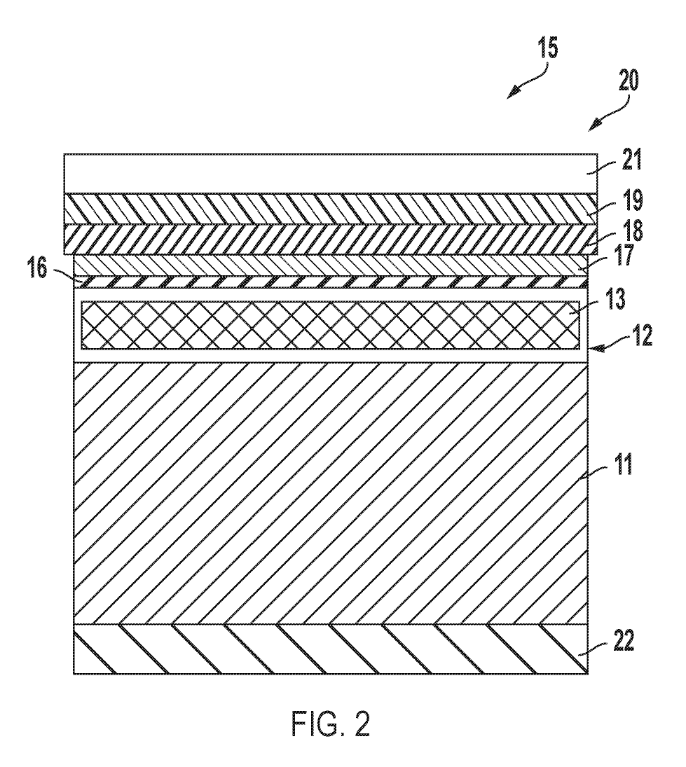

Another consideration to accomplish the herein described deposition of disperse dyes 16 onto the substrate 11 is the amount of dyestuff that should be deposited onto the transfer media 17 (see FIG. 2). To accomplish the degree of vibrancy desired for an image deposited on a metallic substrate, a higher loading level of dye is required than can normally be deposited by typical, small format consumer printers. When a coating comprising high loading levels of nano particulate is decorated using small format printers, the limited volume of dyestuff impedes the saturation of the image 16 (see FIG. 2) into the additives 13 of the coating 12, and as such the process fails to achieve the desired vibrancy and intensity in the final image. Larger format printers and in particular RIP (Raster Image Processor) controlled printers are more capable of producing these nano-particulate rich coatings by the increased volume of dyestuff they may deposit. Therefore, in the preferred embodiment usage of a RIP to increase the dyestuff deposited onto the transfer media 17 may be required to achieve sufficient diffusion of dye into coating 12 to provide satisfactory results.

Referring now to FIG. 2 is may be seen the coated aluminum piece 10 from FIG. 1 now positioned in an arrangement 15 within a heat press 20 prepared to receive the transfer of a graphic image 16 from a printed transfer paper media 17. The layering from the top of the stack of elements depicted in this cross-sectional view includes a steel heat platen 19 supported by lifting member 21 heated to 400 degrees F., a porous PTFE coated Fiberglass sheet 18 to protect the platen 19 and provide for a breathable interface between the platen 19 and the transfer paper 17. Below the breather liner 18 is transfer paper 17 having an image 16 printed thereon with disperse dyes that may be deposited via a suitable inkjet printer. The paper is oriented with print side facing downward against the coated side 12 of the coated substrate 11 as described in FIG. 1. The aluminum substrate 11 is supported by a porous ceramic insulation layer 22 which prevents heat from dissipating from any material supporting the aluminum substrate below it. The ceramic insulation 22 furthermore allows for moisture of other gases to wick from the substrate 11 during the heating process.

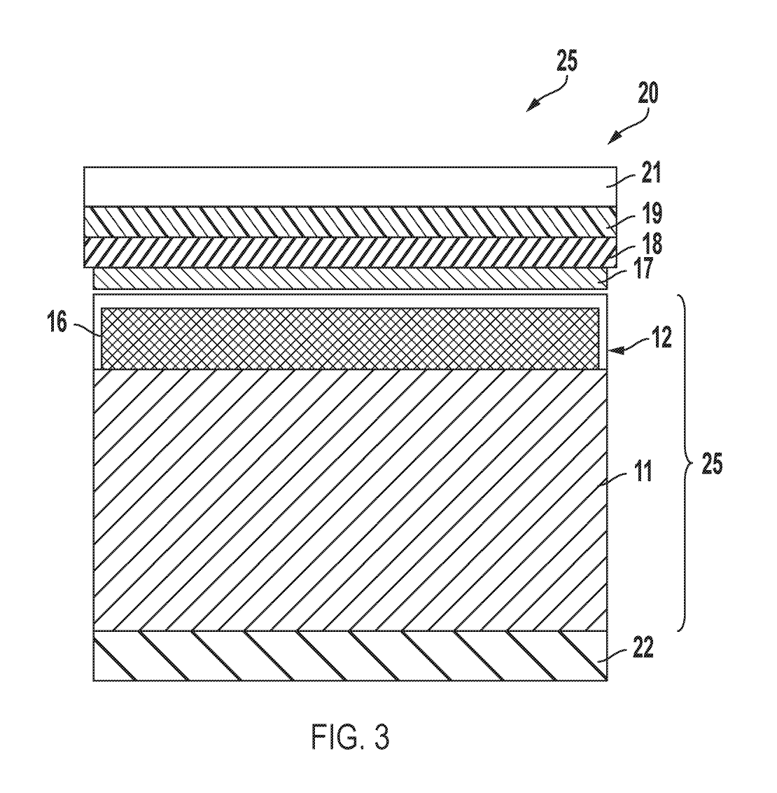

As shown in FIG. 3, disperse dyes 16 held by transfer paper 17 have turned into gases by a sublimation phase change process and have diffused into the receptive polymer coating 12 thoroughly until reaching the surface of aluminum substrate 11. This occurs after the assembly has been subjected to 400 degrees F. for 1 minute under a pressure of 30 PSI, and results in a decorated aluminum article 25 of a size and shape determined by the original size and shape of the uncoated aluminum substrate when removed from the heat press 20. As may be understood, the process may be automated in a rolling assembly process in which the coating 12 and image 16 may be applied along a preformed roll of aluminum that can be cut to a predetermined size and shape after the coating of the substrate 12 and deposition of the image 16 on a timed section of that substrate 12 as it rolls along a moving conveyor of material.

The industrial applicability of the present invention is broad. Products decorated in the manner described can be employed in commercial and residential wall photos, exterior promotional signage, table and desktop photographs contained in self-standing aluminum frames, aluminum window murals and collages, aluminum cutting boards, metal placemats, pre-fabricated POS counter areas, hanging ornaments, aluminum lighting fixtures, candle accessories, and an almost unlimited array of other imprintables. The implication to photography itself is also significant as the invention provides for a completely different iridescent media for photographs that includes a full color spectrum of color including bright solid whites and rich blacks.

While I have shown my invention in one form, it will be obvious to those skilled in the art that it is not so limited but is susceptible of various changes and modifications without departing from the spirit thereof.

Having set forth the nature of the invention, what is claimed is:

1. A decorated metal article, comprising:
a. a metal substrate having a surface capable of accepting an organic polymer coating;
b. an organic polymer coating applied to said metal surface having a mixture of urethane polymer and light scattering particles, wherein said light scattering particles comprise a size of between 5 nm and 400 nm and are combined with said urethane at a loading level of between 5% and 40% by weight of solids;
c. a human discernable image diffused into said polymer coating using a dye sublimation process, wherein said discernable image is comprised of disperse dye converted from a solid state into a gaseous state prior to diffusion into said coating; and,
d. wherein said coated metal article exhibits metal iridescence after the application of said polymer and said image to said metal substrate such that said human discernable image exhibits enhanced luminosity resulting from light reflected from said metal surface.

2. A decorated article as recited in claim 1, wherein said light scattering particles comprise metal oxides selected from the group consisting of aluminum oxide, zinc oxide, titanium dioxide, silver oxide, and zirconium oxide.

3. A decorated article as recited in claim 1, wherein the amount of added light scattering particles to said urethane does not substantially block reflected iridescent luminosity from said metal surface.

4. A decorated article as recited in claim 3, wherein said light scattering particles comprise aluminum oxide.

5. A decorated article as recited in claim 4, wherein said coating is cured in the presence of a polymerizing catalyst such that said coating is polymerized.

6. A decorated article as recited in claim 5, wherein said metal substrate comprises aluminum.

7. A decorated article as recited in claim 1, wherein said dye receptive coating comprises a thickness of at least 0.0015 inches.

8. A decorated article as recited in claim 7, wherein said aluminum substrate is a least 0.023 inches thick.

9. A decorated article as recited in claim 1, wherein the ratio of light scattering particles to loading level by weight comprises a tailored ratio to promote artistic lighting enhancement of said human discernable image.

10. A decorated article as recited in claim 9, wherein said polymer coating is translucent.

11. A decorated article as recited in claim 10, wherein said polymer coating comprises a mixture of urethan and polyester bases.

12. An undecorated metal article capable of receiving a human discernable image through dye sublimation, comprising:
a. a metal substrate having a surface capable of accepting an organic polymer coating;
b. an organic polymer coating applied to said metal surface having a mixture of urethane polymer and light scattering particles, wherein said light scattering particles comprise a size of between 5 nm and 400 nm and are combined with said urethane at a loading level of between 5% and 40% by weight of solids;
c. wherein said coating exhibits metal iridescence after the application of said coating to said metal substrate; and,
d. wherein said coating is adapted to receive a human discernable image diffused into said polymer coating using a dye sublimation process, wherein said discernable image is comprised of disperse dye converted from a solid state into a gaseous state prior to diffusion into said coating.

13. An undecorated article as recited in claim 12, wherein said light scattering particles comprise metal oxides selected from the group consisting of aluminum oxide, zinc oxide, titanium dioxide, silver oxide, and zirconium oxide.

14. An undecorated article as recited in claim 13, wherein the amount of added light scattering particles to said urethane does not substantially block reflected iridescent luminosity from said metal surface.

15. An undecorated article as recited in claim 12, wherein said light scattering particles comprise aluminum oxide.

16. An undecorated article as recited in claim 12, wherein said light scattering particles comprise naturally occurring metal oxides.

17. The article as recited in claim 16, wherein said dye receptive coating comprises a thickness of at least 0.0015 inches.

18. A decorated metal article, comprising:
a. a human discernable image prepared for sublimation by applying disperse dyes to a transfer media sheet suitable for dye sublimation;
b. a polymer coating that scatters light reflected from the surface of said metal article prepared by mixing a base of urethane polymer and light scattering particles, wherein said light scattering particles comprise an average size of between 5 nm to 400 nm and are combined with said urethane at a loading level of between 5% and 40% by weight of solids;
c. wherein said metal includes a portion of its surface covered by said polymer coating to a thickness of at least 0.0015 inches and is cured upon said same; and,
d. wherein said coated metal surface includes a sublimated, human discernable image by compressing said transfer media sheet against said coated side of said metal surface under at least 5 PSI of pressure and at a temperature of at least 350 degrees Fahrenheit until said human discernable image is sublimated into said coating and cooled.

19. The decorated metal article as recited in claim 18, wherein said human discernable image is formed by applying a temperature of between 360 and 400 degrees Fahrenheit and simultaneously applying a pressure of between 5 and 40 PSI.

20. The decorated metal article as recited in claim 19, wherein said human discernable image comprises a photograph.

21. A method for making a metal surface receptive for applying a dye-sublimated image, comprising the steps of:
a. preparing a mixture of urethane polymer and light scattering particles, wherein said light scattering particles comprise an average size of between 5 nm to 400 nm and are combined with said urethane at a loading level of between 5% and 40% by weight of solids;
b. coating one side of the surface of said metal article with said polymer mixture to a thickness of at least 0.0015 inches and curing said same; and,
c. curing said coating in the presence of a catalyst such that said coating becomes polymerized.

22. The method as recited in claim 21, wherein dye receptive composite coating comprises a clear acrylic urethane coating modified by the addition of a light scattering pigment of titanium dioxide having an average particle size of 100 nm at a loading level of 20% by weight of solids.

23. The method as recited in claim 21, wherein the loading step of said light scattering particles in said polymer mixture and the thickness of said polymer applied to said metal surface are tailored to promote metal surface reflectivity in accordance with the degree of reflectivity exhibited by said metal surface and in accordance with the type of subject matter exhibited by said human discernable image.
